(19) United States
(12) Patent Application Publication
(10) Pub. No.: US 2026/0265424 A1
(43) Pub. Date: Sep. 10, 2026

(54) RECYCLED MMA AND USE THEREOF IN A CONTINUOUS POLYMERIZATION PROCESS

(71) Applicant: Röhm GmbH, Darmstadt (DE)

(72) Inventors: Steffen Krill, Muehltal (DE); Johannes Vorholz, Alzenau (DE); Timm Schuhmann, Bensheim (DE); Patrick Wings, Koeln (DE)

(73) Assignee: Röhm GmbH, Darmstadt (DE)

(21) Appl. No.: 19/166,144

(22) PCT Filed: Mar. 15, 2024
(86) PCT No.: PCT/EP2024/056992

§ 371 Date: Sep. 17, 2025

(30) Foreign Application Priority Data
Mar. 22, 2023 (EP) 23163407.2

(51) Int. Cl. C08F 20/12

(52) U.S. Cl. CPC C08F 20/12

(57) ABSTRACT

A novel process produces a poly(alkyl (meth)acrylate). In this process, a polymer composition having at least one poly(alkyl (meth)acrylate) is first thermally cracked to obtain at least one alkyl (meth)acrylate and at least one further alkyl ester. This mixture is then condensed and mixed with a stream from a poly(alkyl (meth)acrylate) production process. Polymerization then affords the poly(alkyl (meth)acrylate).

### FIELD OF THE INVENTION

The present invention relates to a novel process for producing a poly(alkyl (meth)acrylate). In this process, a polymer composition comprising at least one poly(alkyl (meth)acrylate) is first thermally cracked to obtain at least one alkyl (meth)acrylate and at least one further alkyl ester. This mixture is then condensed and mixed with a stream from a poly(alkyl (meth)acrylate) production process. Polymerization then affords the poly(alkyl (meth)acrylate).

### Prior Art

Alkyl (meth)acrylates, especially methyl methacrylate (MMA), have a wide range of use.

MMA is used in particular for production of polymethylmethacrylate (PMMA), which features excellent optical properties, in particular high transparency and weathering resistance (acrylic glass), and other physical properties. Its fields of use include glazing and facades in architecture, lighting elements and vehicle taillights in the automotive sector, aircraft windows, decoration, design or furniture elements, flat screens and displays, noise barriers and illuminated advertising.

Processing of PMMA results in production waste, called post-industrial waste. Post-industrial wastes include, in particular, offcuts and general wastes that arise in the production process and in subsequent processing during and after extrusion or casting of PMMA molding compounds.

Products made from PMMA molding compounds, for example greenhouse glazing, noise barriers, aircraft glazing, spit screens or display screens, and also colored molding compounds as used in the automotive sector inter alia (e.g. light guides, taillights and bodywork parts), after use, are usually disposed of on the part of the customer and sent to landfill together with other types of plastic waste or thermally disposed of and incinerated in a power plant. Such used materials are typically referred to as post-consumer waste. In addition, post-consumer waste such as electrical scrap and waste equipment frequently also contains PMMA as contaminants of the sorting process alongside other plastics and additives. The proportion of MMA units in the PMMA polymers present in the waste varies and may range from 75% to more than 99%.

PMMA, both as post-industrial waste and post-consumer waste, can in principle be depolymerized to its monomers and reused as what is called recycled MMA. Various methods of depolymerization are described in the prior art, such as depolymerization in metal baths, rotary furnaces, fluidized bed reactors or extruders.

For example, documents DE 642289 C, U.S. Pat. No. 2,030,901, DE 3146194 A1, EP 3 635 043 and U.S. Pat. No. 2,470,361 describe the thermal depolymerization of PMMA, in some cases with subsequent purification of the monomers obtained, for example by distillation.

Thermally catalyzed depolymerizations of PMMA with subsequent purification of the monomers obtained are described, for example, in U.S. Pat. No. 2,858,255, DE 2132716, WO 2019/003253, DE 19729065 and EP 2 895 576.

Likewise known is the depolymerization of PMMA, in some cases together with other polymers, in a fluidized bed. This is described, for example, in U.S. Pat. No. 5,663,420, WO 2000/017149 and U.S. Pat. No. 8,304,573.

U.S. Pat. No. 3,494,958 describes a thermal depolymerization process for PMMA. The monomer obtained can then be purified by distillation. U.S. Pat. No. 3,494,958 states that the purification can be effected, for example, analogously to the purification in an ACH process (C₃ process).

The processes described above frequently have an inadequate yield of monomers. Moreover, the processes described in the prior art afford recycled alkyl (meth)acrylates of insufficient purity for production of poly(alkyl (meth)acrylates) of sufficient quality. This is the case in particular when poly(methyl methacrylate) used in the depolymerization processes contains a high proportion of additives, such as impact modifiers or pigments and/or other polymers.

As a result, recycled alkyl (meth)acrylate, in particular recycled MMA, is distinctly different in terms of quality from that of pure alkyl (meth)acrylate, in particular pure MMA which is obtained directly from MMA production processes. The MMA content in recycled MMA typically does not attain the standard commercial specification of a purity of 99.8% by weight for pure MMA. There are often several hundred ppm to several thousand ppm of troublesome substances that have an adverse effect on the production of high-purity PMMA pellets from recycled MMA.

Depending on which post-industrial waste and/or post-consumer waste is used for production of recycled MMA, the recycled MMA also has intolerable coloring and/or odor. The latter may come, for example, from sulfur-containing regulators and other additives that are released in the course of thermal depolymerization and can be converted to odorous mercaptans.

Therefore, it is currently possible to use recycled MMA from a depolymerization process directly as raw material in a continuous PMMA polymerization.

Because of their low purity, the recycled alkyl (meth)acrylates have only a limited field of application. In particular, they can only be used to a limited degree for production of poly(alkyl (meth)acrylates).

Popescu et al. “The characterization of recycled PMMA”, Journal of Alloys and Compounds, vol. 483, p. 432-436, describes the physical properties of PMMA produced from recycled MMA that has been produced by depolymerization of PMMA.

Kikuchi et al. “Design of recycling system for poly(methyl methacrylate) (PMMA). Part 1: recycling scenario analysis” Int. J. Life Cycle Assess (2014) 19:120-129 describes the depolymerization of PMMA and the purification of the recycled MMA thus obtained by distillation.

DE 10 2007 045 156 A1 describes a vented extruder for degassing of a polymer material. The use of recycled MMA is not disclosed.

### Object

There is therefore a need to provide an improved process for producing a poly(alkyl (meth)acrylate) that has the disadvantages of the processes described in the prior art only to a reduced degree, if at all.

It was additionally an object of the present invention to use recycled alkyl (meth)acrylates having a purity below that of alkyl (meth)acrylates from alkyl (meth)acrylate production processes at least in some proportion for the production of on-spec poly(alkyl (meth)acrylates). Troublesome substances that are present should be effectively removable in the poly(alkyl (meth)acrylate) production process.

In particular, the process should have lower emission of wastes that affect the climate, such as CO₂.

### Achievement

This object was achieved by a process for producing a poly(alkyl (meth)acrylate) comprising the following steps a) to h):
a) thermally cracking at least one polymer composition comprising at least one poly(alkyl (meth)acrylate) to obtain a first gas stream comprising at least one alkyl (meth)acrylate and at least one further alkyl ester,
b) condensing the first gas stream obtained in step (a) to obtain a first liquid stream comprising the at least one alkyl (meth)acrylate and the at least one further alkyl ester,
c) mixing the first liquid stream obtained in step b) with a further stream comprising at least one further alkyl (meth)acrylate, the further stream being part of a poly(alkyl (meth)acrylate) preparation process, to obtain a mixture stream comprising the first liquid stream and the further stream,
e) partly polymerizing the mixture stream obtained in step c) to obtain a syrup comprising at least one alkyl (meth)acrylate in partly polymerized form, at least one further alkyl (meth)acrylate in partly polymerized form, and the at least one further alkyl ester,
f) polymerizing the syrup obtained in step e) in a vented extruder to obtain a polymer mixture comprising the poly(alkyl (meth)acrylate),
g) degassing the syrup obtained in step e) and/or the polymer mixture obtained in step f) in the vented extruder to obtain a condensate stream comprising the at least one alkyl (meth)acrylate, the at least one further alkyl (meth)acrylate, oligomers thereof and the at least one further alkyl ester,
h) separating the at least one further alkyl ester from the condensate stream obtained in step g) to obtain an alkyl (meth)acrylate stream comprising the at least one alkyl (meth)acrylate and the at least one further alkyl (meth)acrylate.

This object was also achieved by a process for producing a poly(alkyl (meth)acrylate) comprising the following steps a) to h):
a) thermally cracking at least one polymer composition comprising at least one poly(alkyl (meth)acrylate) to obtain a first gas stream comprising at least one alkyl (meth)acrylate and at least one further alkyl ester, where the at least one alkyl (meth)acrylate present in the first gas stream is selected from the group consisting of C₁- to C₄-alkyl (meth)acrylates,
b) condensing the first gas stream obtained in step a) to obtain a first liquid stream comprising the at least one alkyl (meth)acrylate and the at least one further alkyl ester,
c) mixing the first liquid stream obtained in step b) with a further stream comprising at least one further alkyl (meth)acrylate, the further stream being part of a poly(alkyl (meth)acrylate) production process, to obtain a mixture stream comprising the first liquid stream and the further stream, where up to 50% by weight of the first liquid stream is mixed with the further stream, based on the total weight of the mixture stream obtained,
e) partly polymerizing the mixture stream obtained in step c) to obtain a syrup comprising at least one alkyl (meth)acrylate in partly polymerized form, at least one further alkyl (meth)acrylate in partly polymerized form, and the at least one further alkyl ester,
f) polymerizing the syrup obtained in step e) in a vented extruder to obtain a polymer mixture comprising the poly(alkyl (meth)acrylate),
g) degassing the syrup obtained in step e) and/or the polymer mixture obtained in step f) in the vented extruder to obtain a condensate stream comprising the at least one alkyl (meth)acrylate, the at least one further alkyl (meth)acrylate, oligomers thereof and the at least one further alkyl ester,
h) separating the at least one further alkyl ester from the condensate stream obtained in step g) to obtain an alkyl (meth)acrylate stream comprising the at least one alkyl (meth)acrylate and the at least one further alkyl (meth)acrylate.

It has been found that, surprisingly, the process of the invention affords poly(alkyl (meth)acrylate) having a purity of >99%.

The poly(alkyl (meth)acrylates), in particular polymethyl (meth)acrylate, produced by the process of the invention, have sufficient purities in particular for the production of colored poly(alkyl (meth)acrylates), in particular colored polymethyl (meth)acrylates. In some cases, the poly(alkyl (meth)acrylates), in particular polymethyl (meth)acrylate, produced by the process of the invention, even have such high purity levels that they are suitable for production of crystal-clear poly(alkyl (meth)acrylates), in particular crystal-clear polymethyl (meth)acrylate. The poly(alkyl (meth)acrylates) produced by the process of the invention also have high transmission at 450 nm and a low yellowness value coupled with a simultaneously sufficiently high Vicat softening temperature.

In particular, the process of the invention is surprisingly capable of removing by-products such as further alkyl esters in a particularly efficient manner, such that they do not contaminate the poly(alkyl (meth)acrylates) produced, even if their normal boiling temperature differs only slightly, for example by +/−1 K (kelvin), preferably +/−0.6 K, from the normal boiling temperature of the alkyl (meth)acrylate. This is due in particular to process steps g) and h).

Additives and chain regulators that may be present in the polymer composition, and the products obtained therefrom in the thermal cracking of the polymer composition, such as mercaptans, can be easily and inexpensively removed by the process of the invention. For example, the poly(alkyl (meth)acrylate) obtained in the process of the invention contains a maximum of 0.5% by-products. Because of the process of the invention and the efficient removal of the by-products that is thereby possible, the poly(alkyl (meth)acrylates) produced in accordance with the invention have only very minor odor, if any, in spite of the mercaptans present in the polymer composition.

The process of the invention and the poly(alkyl (meth)acrylates) produced by the process of the invention also have a lower CO₂ emission and hence a particularly low carbon footprint. This is achieved in particular in that the process of the invention also allows the use of polymer compositions having a relatively high proportion of additives and other impurities and in that the raw material source is reusable.

The process of the invention is thus superior to those previously known, since it meets the requirement of itself being capable of reuse in the recycling chain (circular economy).

In addition, the by-products obtained in the depolymerization can be reused after being separated off, such that the carbon footprint and hence the global warming potential (GWP) are reduced further.

The process of the invention is elucidated in detail hereinafter.

In step a) of the process of the invention, at least one polymer composition is thermally cracked to obtain a first gas stream. The at least one polymer composition contains at least one poly(alkyl (meth)acrylate). The gas stream contains at least one alkyl (meth)acrylate and at least one further alkyl ester.

What is meant by the expression “at least one polymer composition” in the context of the present invention is either exactly one polymer composition or a mixture of two or more polymer compositions. Preference is given in accordance with the invention to a mixture of two or more polymer compositions.

The at least one polymer composition contains at least one poly(alkyl (meth)acrylate).

What is meant by “at least one poly(alkyl (meth)acrylate)” in the context of the present invention is either exactly one poly(alkyl (meth)acrylate) or a mixture of two or more poly(alkyl (meth)acrylates). “Polyalkyl (meth)acrylates” in the context of the present invention mean polymers and copolymers of alkyl (meth)acrylates.

Copolymers of alkyl (meth)acrylates are, for example, copolymers of alkyl (meth)acrylates with 1-alkenes, other alkyl (meth)acrylates, (meth)acrylic acid, styrene, polyesters, vinyl esters and/or polyurethane (meth)acrylates.

1-Alkenes capable of copolymerization with alkyl (meth)acrylates are known as such and are, for example, 1-hexene, 1-heptene, vinylcyclohexane, 3,3-dimethyl-1-propene, 3-methyl-1-diisobutylene and 4-methylpent-1-ene.

The term “styrene” in the context of the present invention means not only styrene as such but also substituted styrenes, for example α-methylstyrene, α-ethylstyrene, vinyltoluene, p-methylstyrene, monochlorostyrenes, dichlorostyrenes and tribromostyrenes.

Suitable polyesters are known per se and are preferably obtainable via polycondensation or ring-opening polymerization.

“Polyurethane (meth)acrylates” in the context of the present invention mean (meth)acrylates joined to one another via urethane groups. They are obtainable by reaction of hydroxyalkyl (meth)acrylates with polyisocyanates and polyoxyalkylenes having at least two hydroxy functionalities. Instead of hydroxyalkyl (meth)acrylates, it is also possible to use esters of (meth)acrylic acid with oxiranes, for example ethylene oxide or propylene oxide, or corresponding oligooxiranes or polyoxiranes. Suitable polyurethane (meth)acrylates are known per se.

The at least one polymer composition may originate, for example, from production waste. In that case, the polymer composition is typically what is called post-industrial waste, for example sprues, lumps formed in the startup of extrusion, dusts, chips, partly polymerized polymer syrups, edge sections, offcuts in the case of sheets, reject material in the case of sheets, films, blocks, semifinished products, malformed moldings or injection molding waste.

It is also possible that the at least one polymer composition comes from what is called post-consumer waste. This typically comprises waste, for example, from electrical scrap and waste equipment, greenhouses, trade fair constructions, shopfitting material or illuminated advertising.

The at least one polymer composition therefore usually contains at least one further component. The at least one further component is selected, for example, from the group consisting of polymers other than the poly(alkyl (meth)acrylate), pigments, dyes, fillers, auxiliaries, chain transfer agents, initiators, impact modifiers, release agents and UV additives.

Preference is therefore also given to a process in which the polymer composition in step a) comprises at least one further component selected from the group consisting of polymers other than poly(alkyl (meth)acrylate), pigments, dyes, fillers, auxiliaries, chain transfer agents, initiators, impact modifiers, release agents and UV additives.

Polymers other than poly(alkyl (meth)acrylate) are especially those polymers that can typically be used as a blend with poly(alkyl (meth)acrylate). These include, for example, polyethylene, polyvinylchloride, polystyrene, polyamides and biopolymers such as α-polysaccharides (starch), β-polysaccharides (cellulose, chitin), lignin and polylactide.

Pigments are, for example, white, red, blue, green and/or yellow inorganic pigments. Particular preference is given to white inorganic pigments such as titanium dioxide.

Dyes are, for example, organic dyes known to the person skilled in the art.

Typical fillers are in particular mineral fillers. Mineral fillers are preferably selected from the group consisting of calcium carbonate, barium sulfate, quartz, ground quartz, precipitated silicas, fumed silicas, corundums, glass beads and cristobalites.

Typical auxiliaries are known as such and are selected, for example, from the group consisting of plasticizers, paraffins and/or inhibitors.

Plasticizers used are preferably esters, polyols, oils, low molecular weight polyethers or phthalates.

Paraffins that may be present in the polymer composition are known as such. For example, several paraffins with different melting points may be present in different concentrations.

Compounds present from the group of inhibitors are preferably substituted phenols, hydroquinone derivatives, phosphines and/or phosphites.

Chain transfer agents are in particular compounds known from free-radical polymerization that control chain length. Chain transfer agents typically include mercaptans such as n-dodecyl mercaptan, but also polyfunctional mercapto compounds such as pentaerythritol tetrathioglycolate.

Initiators are likewise known as such and are selected, for example, from the group consisting of peroxides, azo compounds, persulfates and mixtures thereof.

Impact modifiers are known as such and are, for example, polymer particles containing an elastomer.

Release agents especially include long-chain wax acids, such as stearic acid, palmitic acid or lauric acid, and also monofunctional fatty alcohols or wax alcohols, for example diethylene glycol monopropyl ether.

UV additives especially include UV stabilizers. The UV stabilizers are preferably selected from the group consisting of benzophenone derivatives, benzotriazole derivatives, thioxanthonate derivatives, piperidinol carboxylic ester derivatives and cinnamic ester derivatives.

The thermal cracking of the at least one polymer composition can be effected by methods known to the person skilled in the art.

The thermal cracking can be performed in reactors known to the person skilled in the art for thermal cracking. For example, the thermal cracking can be performed in a pyrolysis reactor, in an extruder, in a rotary furnace, in a fluidized bed pyrolysis, in a metal bath and/or as dry distillation.

The polymer composition may be in solid or liquid form in the thermal cracking operation. If the polymer composition is in solid form, it may take the form of a pure solid. It is also possible that the polymer composition in solid form is dispersed in a medium. The medium in which the polymer composition may be dispersed may, for example, be a solid, such as quartz, metal turnings or kieselguhr. It is likewise possible that the medium is a gas, for example nitrogen, or a liquid, for example water or a hydrocarbon. It is possible that the medium is a liquid at room temperature, but is a gas under the conditions of the thermal cracking in step a).

For example, the polymer composition is in liquid (molten) form when the thermal cracking is effected in an extruder.

The polymer composition, especially when it is in solid form, may be mechanically crushed prior to thermal cracking, for example to an average particle size distribution of less than 6 mm (Qr, d50), preferably less than 1.5 mm (Qr, d50), for example to a particle size distribution in the range from 0.1 mm (Qr, d50) to 6 mm (Qr, d50). Particle size distribution is preferably determined by laser diffraction.

The temperature (T) in the thermal cracking in step a) is, for example, within a range from 240° C. to 800° C., preferably in the range from 300° C. to 500° C., more preferably in the range from 325° C. to 400° C.

The pressure in the thermal cracking in step a) is, for example, in the range from 200 mbar to 1000 bar, preferably in the range from 400 mbar to 500 bar.

Preference is therefore also given in accordance with the invention to a process in which the thermal cracking temperature in step a) is in the range from 240° C. to 800° C. and/or the thermal cracking pressure in step a) is in the range from 400 mbar to 500 bar.

The thermal cracking in step a) can be effected in the presence of a catalyst. Catalysts suitable for the thermal cracking are known as such and are selected, for example, from the group consisting of molten metal, peroxides, potassium salts, for example potassium acetate, and alkali metal persulfates, for example potassium monopersulfate. Suitable molten metals are especially lead and/or eutectic lead/tin mixtures.

If the thermal cracking in step a) is effected in the presence of a catalyst, the cracking in step a) is also referred to as thermal catalytic cracking.

Preference is therefore also given in accordance with the invention to a process in which the thermal cracking in step a) is a thermally catalytic cracking operation.

The thermal cracking operation in step a) cracks the poly(alkyl (meth)acrylate). This cracking is also referred to as depolymerization. Depolymerizations as such are known to the person skilled in the art. Depolymerization involves cracking a polymer into its monomer and oligomer units.

In the course of the thermal cracking in step a), the poly(alkyl (meth)acrylate) is thus cracked into its monomer and oligomer units. As set out above, the poly(alkyl (meth)acrylate) is a polymer or copolymer of at least one alkyl (meth)acrylate. In the course of the thermal cracking, therefore, at least one alkyl (meth)acrylate is formed.

In the course of the thermal cracking of the polymer composition, at least one further alkyl ester is additionally formed. What is meant by “at least one further alkyl ester” in the context of the present invention is either exactly one further alkyl ester or a mixture of two or more further alkyl esters. A mixture of two or more further alkyl esters is preferred in accordance with the invention.

The first gas stream therefore contains the at least one alkyl (meth)acrylate formed in the thermal cracking operation and the at least one further alkyl ester.

The at least one alkyl (meth)acrylate, as set out above, is derived from the poly(alkyl (meth)acrylate).

What is meant by “at least one alkyl (meth)acrylate” in the context of the present invention is either exactly one alkyl (meth)acrylate or a mixture of two or more alkyl (meth)acrylates. A mixture of two or more alkyl (meth)acrylates is preferred.

“Alkyl (meth)acrylates” in the context of the present invention mean alkyl esters of (meth)acrylic acid which have 1 to 18, preferably 1 to 12, especially preferably 1 to 4, carbon atoms in the alkyl radical. The alkyl radical may be linear, cyclic and/or branched. In addition, it may include aromatic radicals. The alkyl radical may additionally have heteroatoms within the alkyl radical and/or be substituted by heteroatoms, as is the case, for example, in hydroxypropyl (meth)acrylate and/or hydroxyethyl (meth)acrylate. For example, alkyl (meth)acrylates of the invention are selected from the group consisting of methyl (meth)acrylate, ethyl (meth)acrylate, 1-methylethyl (meth)acrylate, propyl (meth)acrylate, n-butyl (meth)acrylate, isobutyl (meth)acrylate, 2-ethylhexyl (meth)acrylate, isopentyl (meth)acrylate, cyclohexyl (meth)acrylate, tetrahydrofurfuryl (meth)acrylate, allyl (meth)acrylate, polyethylene glycol (meth)acrylate, stearyl (meth)acrylate, benzyl (meth)acrylate, vinyl (meth)acrylate, hydroxypropyl (meth)acrylate, hydroxyethyl (meth)acrylate and lauryl (meth)acrylate.

In a further embodiment of the present invention, “alkyl (meth)acrylates” also mean polyethylene glycol (meth)acrylates having a weight-average molecular weight Mw in the range from 250 g/mol to 10 000 g/mol.

The term “(meth)acrylic acid” in the context of the present invention encompasses both acrylic acid and methacrylic acid. The term “(meth)acrylates” in the context of the present invention encompasses both acrylates and methacrylates.

“Alkyl (meth)acrylates” in the context of the present invention therefore mean both alkyl acrylates and alkyl methacrylates. Alkyl methacrylates are preferred in accordance with the invention. The at least one alkyl (meth)acrylate is, for example, a C₁-C₁₈-alkyl (meth)acrylate, preferably a C₁-C₁₂-alkyl (meth)acrylate and more preferably a C₁-C₄-alkyl (meth)acrylate. Most preferably in accordance with the invention, the at least one alkyl (meth)acrylate comprises methyl (meth)acrylate.

Preference is therefore also given to a process in which the at least one alkyl (meth)acrylate present in the first gas stream in step a) is selected from the group consisting of C₁- to C₄-alkyl (meth)acrylates.

The at least one alkyl (meth)acrylate has, for example, a boiling temperature at standard pressure in the range from 50° C. to 300° C., preferably in the range from 80° C. to 250° C.

It will be apparent that the at least one further alkyl ester is different than the at least one alkyl (meth)acrylate. The at least one further alkyl ester preferably does not include any (meth)acrylate unit.

For example, the at least one further alkyl ester is selected from the group consisting of C₁-C₄-alkyl isobutyrates, C₁-C₄-alkyl propionates, C₁-C₄-alkyl pivalates and dicarboxylic diesters.

C₁-C₄-alkyl isobutyrates in the context of the present invention mean alkyl esters of isobutyric acid that have 1 to 4 carbon atoms in the alkyl radical. The alkyl radical may be linear or branched. It may additionally have heteroatoms within the alkyl radical and/or be substituted by heteroatoms. A C₁-C₄-alkyl isobutyrate that has heteroatoms within the alkyl radical is, for example, methyl 2-methoxyisobutyrate and methyl 3-methoxyisobutyrate. C₁-C₄-alkyl isobutyrates of the invention are selected, for example, from the group consisting of methyl isobutyrate, ethyl isobutyrate, methyl 2-methoxyisobutyrate and methyl 3-methoxyisobutyrate.

C₁-C₄-alkyl propionates in the context of the present invention mean alkyl esters of propionic acid that have 1 to 4 carbon atoms in the alkyl radical. The alkyl radical may be linear or branched. It may additionally have heteroatoms within the alkyl radical and/or be substituted by heteroatoms. C₁-C₄-alkyl propionates of the invention are selected, for example, from the group consisting of methyl propionate and ethyl propionate.

C₁-C₄-alkyl pivalates in the context of the present invention mean alkyl esters of pivalic acid that have 1 to 4 carbon atoms in the alkyl radical. The alkyl radical may be linear or branched. It may additionally have heteroatoms within the alkyl radical and/or be substituted by heteroatoms. C₁-C₄-alkyl pivalates of the invention are selected, for example, from the group consisting of methyl pivalate and ethyl pivalate.

Dicarboxylic diesters in the context of the present invention mean alkyl esters of dicarboxylic acids that have 1 to 4 carbon atoms in the alkyl radical. Dicarboxylic diesters likewise include carboxylic esters of diols in which both hydroxyl groups have been esterified with a carboxylic acid. Dicarboxylic diesters of the invention are, for example, selected from the group consisting of dimethyl propanedioate, dimethyl pentanedioate, dimethyl hexanedioate and dimethyl heptanedioate.

The at least one further alkyl ester is preferably selected from the group consisting of methyl propionate, ethyl propionate, methyl isobutyrate, methyl pivalate, methyl 3-methoxyisobutyrate and dicarboxylic diesters.

Preference is therefore also given to a process in which the at least one further alkyl ester is selected from the group consisting of methyl propionate, methyl isobutyrate, methyl pivalate, methyl-3-methoxyisobutyrate and dicarboxylic diesters.

The at least one further alkyl ester has, for example, a boiling temperature at standard pressure in the range from 50° C. to 200° C., preferably in the range from 75° C. to 150° C.

It is further preferable in accordance with the invention that the boiling point at standard pressure of the at least one further alkyl ester differs from the boiling point at standard pressure of the at least one alkyl (meth)acrylate by in the range from −20° C. to +20° C., preferably by in the range from −1° C. to +1° C., more preferably by in the range from −0.6° C. to +0.6° C.

As set out above, the first gas stream is obtained by thermally cracking the at least one polymer composition. The first gas stream therefore typically contains at least one further component. It will be apparent that the at least one further component is different than the at least one alkyl (meth)acrylate and the at least one further alkyl ester.

The at least one further component is formed, for example, by thermal cracking of copolymers of alkyl (meth)acrylate and/or by thermal cracking of the at least one further component optionally present in the at least one polymer composition. In addition, the thermal cracking may also form oligomers of alkyl (meth)acrylate; these are likewise covered by the term “at least one further component” in the context of the present invention.

For example, the at least one further component is selected from the group consisting of styrene, (meth)acrylic acid, sulfur compounds, oligomers, dimers, C₁-C₄-alkyl acids, di(meth)acrylate diesters, C₁-C₄ alcohols, high-boiling aromatics, aldehydes and ketones; preferably, the at least one further component is selected from the group consisting of styrene, (meth)acrylic acid, sulfur compounds, oligomers and dimers.

Preference is therefore also given to a process in which the first gas stream comprises at least one further component selected from the group consisting of styrene, (meth)acrylic acid, sulfur compounds, oligomers and dimers.

High-boiling aromatics in the context of the present invention include, for example, phenols, anilines, benzophenones, naphthalenes and/or pyridines, each of which may be substituted or unsubstituted.

Styrene as the at least one further component is accordingly subject to the details and preferences in respect of styrene that have been described further up.

Sulfur compounds are derived in particular from any sulfur-containing chain-transfer agents present in the at least one polymer composition and are in particular mercaptans such as dodecyl mercaptan and polyhydric mercapto compounds such as pentaerythritol tetrathioglycolate.

Oligomers in the context of the present invention are especially oligomers of the at least one alkyl (meth)acrylate, of (meth)acrylic acid and of mixtures thereof. The term “oligomer” includes not only higher oligomers but also lower oligomers, for example trimers, tetramers and pentamers. In particular, the term “oligomer” encompasses a molecule consisting of three to ten units, where the units are obtainable from the at least one alkyl (meth)acrylate, (meth)acrylic acid or mixtures thereof.

Dimers in the context of the present invention especially mean dimers of the at least one alkyl (meth)acrylate, of (meth)acrylic acid and of mixtures thereof.

C₁-C₄-alkyl acids mean aliphatic carboxylic acids having 1 to 4 carbon atoms. The C₁-C₄-alkyl acids may have branches. For example, the C₁-C₄-alkyl acid is selected from the group consisting of formic acid, acetic acid, propionic acid, butyric acid and isobutyric acid.

Di(meth)acrylate diesters mean not only esters of (meth)acrylic acid with a diol but also esters of (meth)acrylic acid with a polyol, for example a triol. For example, the di(meth)acrylate diester is selected from the group consisting of ethylene glycol di(meth)acrylate, propylene glycol di(meth)acrylate, trimethylolpropane tri(meth)acrylate, butane-1,4-diol di(meth)acrylate and butane-1,3-diol di(meth)acrylate.

C₁-C₄ alcohols mean alcohols having 1 to 4 carbon atoms in the alkyl radical. The alkyl radical may be linear or branched. It is likewise possible that the alkyl radical is substituted by heteroatoms. Examples of C₁-C₄ alcohols are methanol, ethanol, ethylene glycol, n-butanol, and isobutanol.

Aldehydes are known as such to the person skilled in the art. For example, the aldehydes are selected from the group consisting of formaldehyde, acetaldehyde, methacrolein and acrolein.

In the context of the present invention, ketones mean both monoketones, for example acetone, and diketones, for example diacetyl. Ketones of the invention are selected, for example, from the group consisting of diacetyl, acetone, acetylacetone and methyl ethyl ketone.

For example, the first gas stream obtained in the thermal cracking operation contains 60% to 99% by weight, preferably 80% to 98% by weight, of the at least one alkyl (meth)acrylate, based in each case on the total weight of the first gas stream.

For example, the first gas stream obtained in the thermal cracking operation contains 0.1% to 10% by weight, preferably 0.5% to 5% by weight, of the at least one further alkyl ester, based in each case on the total weight of the first gas stream.

For example, the first gas stream obtained in the thermal cracking operation contains 0.1% to 30% by weight, preferably 0.5% to 18% by weight, of the at least one further component, based in each case on the total weight of the first gas stream.

In step b), the first gas stream obtained in step a) is condensed to obtain a first liquid stream. The first liquid stream contains the at least one alkyl (meth)acrylate and the at least one further alkyl ester.

The first liquid stream is also referred to as recycled poly(alkyl (meth)acrylate). If the poly(alkyl (meth)acrylate) contains poly(methyl (meth)acrylate), the first liquid stream is also referred to as recycled poly(methyl (meth)acrylate) or recycled PMMA.

The first gas stream can be condensed by methods known to the person skilled in the art; for example, condensation can be effected in a condenser.

For example, the first gas stream is condensed in step b) at a temperature in the range from −10° C. to 100° C.; preferably in the range from 0° C. to 90° C., more preferably in the range from 20° C. to 80° C.

The pressure in the condensation of the first gas stream in step b) is, for example, in the range from 0.1 bar to 1.1 bar, preferably in the range from 0.3 bar to 1 bar and especially preferably in the range from 0.4 bar to 0.8 bar.

The first gas stream is preferably condensed by suction into first gas stream that has already been condensed and cooled, where the first gas stream sucked in then condenses. A substream of the condensed first gas stream can then be separated off as a first liquid stream, and the first gas stream can be sucked back into the condensed and cooled first gas stream.

In the course of condensation, the first gas stream goes from the gas phase into the liquid phase, giving the first liquid stream.

Typically, the at least one alkyl (meth)acrylate present in the first liquid stream is the same at least one alkyl (meth)acrylate that was present in the first gas stream. The at least one alkyl (meth)acrylate present in the first liquid stream is therefore correspondingly subject to the details and preferences described above for the at least one alkyl (meth)acrylate present in the first gas stream.

Typically, the at least one further alkyl ester present in the first liquid stream is the same at least one further alkyl ester that was present in the first gas stream. Therefore, the at least one further alkyl ester present in the first liquid stream is correspondingly subject to the above-described details and preferences as applicable to the at least one further alkyl ester present in the first gas stream.

The first liquid stream may additionally contain any at least one further component present in the first gas stream. The at least one further component is correspondingly subject to the details and preferences described above.

Preferably in accordance with the invention, the first gas stream is distilled after step a) and before step b). This affords a first top stream containing the at least one alkyl (meth)acrylate and the at least one further alkyl ester, and a first bottom stream containing at least one component other than the at least one alkyl (meth)acrylate and the at least one further alkyl ester. In this embodiment, the first top stream obtained in the course of distillation is then condensed in step b).

Preference is therefore also given to a process in which the first gas stream is distilled after step a) and before step b) to obtain a first top stream comprising the at least one alkyl (meth)acrylate and the at least one further alkyl ester, and a first bottom stream comprising at least one component other than the at least one alkyl (meth)acrylate and the at least one further alkyl ester, and the first top stream is condensed in step b).

The first gas stream can be condensed before being distilled after step a) and before step b). Methods of condensation of the first gas stream are known as such and described by way of example further up. Thus, in the context of the present invention, “distillation of the first gas stream” refers not only to the distillation of the first gas stream in the gas phase, but also, and in particular, to the distillation of the first gas stream after it has been condensed.

The first gas stream can be distilled by methods known to the person skilled in the art and in reactors known to the person skilled in the art. For example, the first gas stream can be transferred into a distillation column and/or a rectification column and distilled therein. The distillation of the first gas stream affords components present in the first gas stream that have a higher boiling point than the at least one alkyl (meth)acrylate in the first bottom stream, while components present in the first gas stream that have the same or a lower boiling point than the at least one alkyl (meth)acrylate are obtained in the first top stream.

The distillation may take place, for example, at a temperature in the range from 40 to 140° C. For example, the bottom temperature in the distillation is in the range from 95 to 130° C., more preferably in the range from 97 to 126° C.

The distillation may take place, for example, at a pressure in the range from 10 to 250 mbar, preferably in the range from 15 to 150 mbar.

The distillation of the first gas stream affords a first top stream. The first top stream contains the at least one alkyl (meth)acrylate and the at least one further alkyl ester that were already present in the first gas stream.

The first top stream may additionally contain further components. In particular, the first top stream contains the at least one further component present in the first gas stream that has a lower boiling point than, or just as high a boiling point as, the at least one alkyl (meth)acrylate and the at least one further alkyl ester. Therefore, the first top stream typically contains at least one further component selected from the group consisting of methyl propionate, ethyl propionate, methyl isobutyrate, methyl pivalate, methyl 3-methoxyisobutyrate and dicarboxylic diesters.

For example, the first top stream obtained in the distillation contains 60% to <99.8% by weight, preferably 85% to 98% by weight, of the at least one alkyl (meth)acrylate, based in each case on the total weight of the first top stream.

For example, the first top stream obtained in the distillation contains 0.1% to 10% by weight, preferably 0.5% to 5% by weight, of the at least one further alkyl ester, based in each case on the total weight of the first top stream.

For example, the first top stream obtained in the distillation contains 0.1% to 30% by weight, preferably 0.5% to 14.5% by weight, of the at least one further component, based in each case on the total weight of the first top stream.

In addition, a first bottom stream is obtained. A “bottom stream” in the context of the present invention means not only a bottom product which is removed continuously from the distillation, especially from the reactor, but also a bottom product which, for example in a batchwise mode of operation, remains as distillation residue in the reactor and is removed from the reactor only at a later juncture.

The first bottom stream contains at least one component other than the at least one alkyl (meth)acrylate and the at least one further alkyl ester. This component is typically at least one of the at least one further components present in the first gas stream. In particular, this at least one further component typically has a higher boiling temperature than the at least one alkyl (meth)acrylate present in the first gas stream and than the at least one further alkyl ester present in the first gas stream. For example, this at least one further component is selected from the group consisting of sulfur compounds, high-boiling aromatics, oligomers and dimers. The sulfur compounds, the high-boiling aromatics, the oligomers and the dimers are correspondingly subject to the details and preferences described above for the sulfur compounds present in the first gas stream, the high-boiling aromatics, the oligomers and the dimers.

The first bottom stream therefore preferably contains sulfur compounds, high-boiling aromatics, oligomers and/or dimers.

In step c), the first liquid stream obtained in step b) is mixed with a further stream to obtain a mixture stream. The further stream contains at least one further alkyl (meth)acrylate and is part of a poly(alkyl (meth)acrylate) production process. The mixture stream obtained comprises the first liquid stream and the further stream.

If the further stream contains methyl (meth)acrylate as a further alkyl (meth)acrylate and is part of a poly(methyl (meth)acrylate) production process, the further stream is also referred to as pure methyl (meth)acrylate or pure MMA.

It will be apparent that the first liquid stream is different than the further stream. For example, the first liquid stream contains in the range from 90 to <99.8% by weight of the at least one alkyl (meth)acrylate, based on the total weight of the first liquid stream. For example, the further stream contains at least 99.8% by weight of the at least one further alkyl (meth)acrylate, based on the total weight of the further stream. Preferably, the further stream contains at least 99.8% by weight of methyl (meth)acrylate based on the total weight of the further stream, and the further stream is obtainable by a methyl (meth)acrylate production process using C₁, C₂, C₃ and/or C₄ raw materials (methanol, ethylene, acetone, hydrogen cyanide, isobutene and/or methyl tert-butyl ether). These production processes are known per se to the person skilled in the art.

For example, up to 50% by weight, preferably up to 40% by weight, of the first liquid stream is mixed with the further stream, based on the total weight of the mixture stream obtained. For example, at least 1.5% by weight, preferably at least 5% by weight, of the first liquid stream is mixed with the further stream, based on the total weight of the mixture stream obtained.

Preference is therefore also given to a process in which up to 50% by weight of the first liquid stream is mixed with the further stream in step c), based on the total weight of the mixture stream obtained.

For example, the first liquid stream contains in the range from 90% to <99.8% by weight of the alkyl (meth)acrylate, preferably in the range from 94% to 98% by weight, based in each case on the total weight of the first liquid stream, and 1.5% to 25% by weight, preferably 9% to 15% by weight, of the first liquid stream is mixed with the further stream, based on the total weight of the mixture stream obtained. This embodiment is preferred when the optional step d) is not performed.

If, in a preferred embodiment of the present invention, the optional step d) is performed, the first liquid stream contains, for example, in the range of 90% to <99.8% by weight of the alkyl (meth)acrylate, based on the total weight of the first liquid stream, and 1.5% to 50% by weight, preferably 5% to 20% by weight, of the first liquid stream is mixed with the further stream, based on the total weight of the mixture stream obtained.

Preference is therefore also given to a process in which the first liquid stream contains in the range of 90% to <99.8% by weight of the alkyl (meth)acrylate, based on the total weight of the first liquid stream, and in that 1.5% to 50% by weight of the first liquid stream is mixed with the further stream, based on the total weight of the mixture stream obtained.

The further stream with which the first liquid stream is mixed contains at least one further alkyl (meth)acrylate. What is meant by “at least one further alkyl (meth)acrylate” in the context of the present invention is either exactly one further alkyl (meth)acrylate or a mixture of two or more further alkyl (meth)acrylates. Exactly one further alkyl (meth)acrylate is preferred.

The at least one further alkyl (meth)acrylate present in the further stream is correspondingly subject to the details and preferences described above for the at least one alkyl (meth)acrylate present in the first gas stream. The at least one further alkyl (meth)acrylate is therefore selected, for example, from the group consisting of C₁-C₄-alkyl (meth)acrylates. The alkyl (meth)acrylate present in the further stream is especially preferably methyl (meth)acrylate.

The at least one alkyl (meth)acrylate present in the first liquid stream preferably comprises the same alkyl (meth)acrylate as the alkyl (meth)acrylate included in the at least one further alkyl (meth)acrylate in the further stream.

It is preferable in accordance with the invention that, based on the total weight of the at least one alkyl (meth)acrylate present in the first liquid stream, at least 80% by weight, preferably at least 90% by weight, of the at least one alkyl (meth)acrylate present in the first liquid stream is the same alkyl (meth)acrylate as the at least one further alkyl (meth)acrylate present in the further stream.

The further stream is part of a poly(alkyl (meth)acrylate) production process. A “poly(alkyl (meth)acrylate) production process” in the context of the present invention means a process for producing a poly(alkyl (meth)acrylate) by polymerization of at least one alkyl (meth)acrylate, optionally in the presence of monomers other than the alkyl (meth)acrylate. The polymerization may be, for example, a free-radical or anionic polymerization, preferably a free-radical polymerization. Further preferably, the polymerization is a free-radical polymerization in emulsion, solution or bulk, preferably in bulk. In particular, the polymerization is preferably a free-radical polymerization in bulk, wherein the at least one alkyl (meth)acrylate, optionally in the presence of monomers other than the alkyl (meth)acrylate, is first partly polymerized to obtain a syrup and then the syrup is polymerized in a vented extruder to obtain a polymer mixture containing the poly(alkyl (meth)acrylate).

The poly(alkyl (meth)acrylate) from the poly(alkyl (meth)acrylate) production process may be the same as or different than the poly(alkyl (meth)acrylate) present in the at least one polymer composition. The poly(alkyl (meth)acrylate) from the poly(alkyl (meth)acrylate) production process is correspondingly subject to the details and preferences described above for the poly(alkyl (meth)acrylate) present in the at least one polymer composition.

The poly(alkyl (meth)acrylate) is therefore preferably a poly(methyl (meth)acrylate).

Preference is therefore also given to a process in which the poly(alkyl (meth)acrylate) present in the polymer mixture is a poly(methyl (meth)acrylate).

The further stream is part of a poly(alkyl (meth)acrylate) production process. The further stream may, for example, be a reactant stream, which, for example, comes directly from the production of the at least one further alkyl (meth)acrylate present in the further stream. In addition, it is possible and preferable in accordance with the invention that the further stream is obtained in the poly(alkyl (meth)acrylate) production process. For example, the further stream may be the second top stream described below and/or the condensate stream obtained in step g).

The first liquid stream can be mixed with the further stream by methods known to the person skilled in the art. For example, and preferably in accordance with the invention, the first liquid stream is fed into a plant for producing a poly(alkyl (meth)acrylate) that contains the further stream. The mixture stream obtained is then preferably likewise present in the plant for producing a poly(alkyl (meth)acrylate). The mixture stream is then preferably likewise part of the poly(alkyl (meth)acrylate) production process.

Preference is therefore also given to a process in which the mixture stream obtained in step c) is part of a poly(alkyl (meth)acrylate) production process.

The mixture stream comprises the first liquid stream and the further stream. The mixture stream therefore typically comprises the same components that were present in the first liquid stream and in the further stream. Therefore, the mixture stream typically comprises the at least one alkyl (meth)acrylate, the at least one further alkyl ester, the at least one further alkyl (meth)acrylate and, optionally, the at least one further component.

The first liquid stream may be mixed with the further stream at any point in the poly(alkyl (meth)acrylate) production process. The first liquid stream is preferably mixed with the further stream immediately upstream of or in the purification section of the poly(alkyl (meth)acrylate) production process as described further down. This is advantageous since it is then possible for the at least partial separation of the at least one further alkyl ester to take place in the optional step d) in the purification section of the poly(alkyl (meth)acrylate) production process.

In the optional step d), the at least one further alkyl ester is at least partly separated from the mixture stream obtained in step c) to obtain a purified mixture stream. The purified mixture stream contains the at least one alkyl (meth)acrylate, the at least one further alkyl (meth)acrylate and residues of the at least one further alkyl ester. In step e), the purified mixture stream obtained in step d) is then partly polymerized. The performance of step d) is preferred.

Preference is therefore also given to a process in which the process additionally comprises the following step, step d):
d) at least partly separating the at least one further alkyl ester from the mixture stream obtained in step c) to obtain a purified mixture stream comprising the at least one alkyl (meth)acrylate, the at least one further alkyl (meth)acrylate and residues of the at least one further alkyl ester,
in which case it is the purified mixture stream obtained in step d) that is partly polymerized in step e).

The at least one further alkyl ester can be at least partly separated off by any desired methods. For example, the at least one further alkyl ester can be at least partly separated from the mixture stream obtained in step c) by distillation.

Preferably, the at least one further alkyl ester is at least partly separated off in the purification section of the poly(alkyl (meth)acrylate) production process as described further down.

The purified mixture stream contains residues of the at least one further alkyl ester. The expression “residues of the at least one further alkyl ester” in the context of the present invention means in the range from 0% to 8% by weight, preferably in the range from 0.1% to 3% by weight and especially preferably in the range from 0.1% to 2% by weight of the at least one further alkyl ester, based in each case on the total weight of the purified mixture stream.

In step e) of the process of the invention, the mixture stream obtained in step c) is partly polymerized. This affords a syrup containing at least one alkyl (meth)acrylate in partly polymerized form, at least one further alkyl (meth)acrylate in partly polymerized form, and the at least one further alkyl ester.

If the optional step d) is conducted, what is then partly polymerized in step e) of the process of the invention is the purified mixture stream obtained in step d) to obtain a syrup containing at least one alkyl (meth)acrylate in partly polymerized form, at least one further alkyl (meth)acrylate in partly polymerized form and residues of the at least one further alkyl ester.

“Partial polymerization” in the context of the present invention means that the total degree of conversion of the at least one alkyl (meth)acrylate and the at least one further alkyl (meth)acrylate is in the range from 20% to 60%, preferably in the range from 35% to 50%, based on the amount of at least one alkyl (meth)acrylate and at least one further alkyl (meth)acrylate present in the mixture stream, preferably in the purified mixture stream. The total degree of conversion of the at least one alkyl (meth)acrylate and the at least one further alkyl (meth)acrylate is defined as the ratio of the total amount of the at least one alkyl (meth)acrylate and the at least one further alkyl (meth)acrylate in the syrup obtained in step e) to the total amount of the at least one alkyl (meth)acrylate and the at least one further alkyl (meth)acrylate in the mixture stream obtained in step c). The total amount of the at least one alkyl (meth)acrylate and the at least one further alkyl (meth)acrylate is typically determined by GC analysis.

Preference is therefore also given to a process in which, in the partial polymerization in step e), the total degree of conversion of the at least one alkyl (meth)acrylate and the at least one further alkyl (meth)acrylate is in the range from 20% to 60%, based on the amount of at least one alkyl (meth)acrylate and at least one further alkyl (meth)acrylate present in the purified mixture stream.

The partial polymerization in step e) may take place by methods known to the person skilled in the art. The partial polymerization preferably takes place in the presence of at least one auxiliary.

The at least one auxiliary is also referred to as at least one additive.

Preference is therefore also given to a process in which the partial polymerization in step e) takes place in the presence of at least one auxiliary.

The at least one auxiliary may be supplied to the mixture stream at any point, for example in the reactor described below for partial polymerization. Preferably, the at least one auxiliary is supplied to the mixture stream before the mixture stream is transferred to the reactor.

Suitable auxiliaries as the least one auxiliary are, for example, auxiliaries known to the person skilled in the art that can initiate and/or influence the partial polymerization.

For example, the at least one auxiliary is selected from the group consisting of initiators, chain transfer agents and release agents.

Preference is therefore also given to a process in which the at least one auxiliary is selected from the group consisting of initiators, chain transfer agents and release agents.

The initiators, chain transfer agents and release agents are correspondingly subject to the details and preferences described above.

The partial polymerization in step e) can be effected, for example, by free-radical or anionic means. It is preferably effected by free-radical means. In addition, the partial polymerization may take place in emulsion, solution or bulk. It preferably takes place in bulk. Suitable reactors are those known to the person skilled in the art for partial polymerizations. For example, the partial polymerization may take place in a stirred tank reactor, preferably in a continuous stirred tank reactor.

For example, the partial polymerization temperature in step e) is in the range from 120 to 170° C., preferably in the range from 130 to 160° C.

For example, the partial polymerization takes place at a pressure in the range from 1 to 5 bara, preferably in the range from 1.5 to 3 bara.

The partial polymerization affords a syrup. The syrup contains at least one alkyl (meth)acrylate in partly polymerized form, at least one further alkyl (meth)acrylate in partly polymerized form and the at least one further alkyl ester, and when the optional step d) is conducted residues of the at least one further alkyl ester. In addition, the syrup obtained typically contains the at least one auxiliary that was used in the partial polymerization and/or reaction products thereof.

The expression “at least one alkyl (meth)acrylate in partly polymerized form” in the context of the present invention means that portions of the at least one alkyl (meth)acrylate are polymerized with themselves and/or with the at least one further alkyl (meth)acrylate and that portions of the at least one alkyl (meth)acrylate are present as monomer. The expression “at least one further alkyl (meth)acrylate in partly polymerized form” in the context of the present invention means that portions of the at least one further alkyl (meth)acrylate are polymerized with themselves and/or with the at least one alkyl (meth)acrylate and that portions of the at least one further alkyl (meth)acrylate are present as monomer.

The polymerization of the at least one alkyl (meth)acrylate with itself and/or with the at least one further alkyl (meth)acrylate and the polymerization of the at least one further alkyl (meth)acrylate with itself and/or with the at least one alkyl (meth)acrylate forms polymers of the at least one alkyl (meth)acrylate with itself and/or the at least one further alkyl (meth)acrylate and of the at least one further alkyl (meth)acrylate with itself and/or the at least one alkyl (meth)acrylate. Additionally formed are oligomers of the at least one alkyl (meth)acrylate, the at least one further alkyl (meth)acrylate and mixtures thereof.

“Oligomers” in this context mean oligomers of the at least one alkyl (meth)acrylate, the at least one further alkyl (meth)acrylate and mixtures thereof. The term “oligomer” includes not only higher oligomers but also lower oligomers, for example dimers, trimers, tetramers and pentamers. In particular, the term “oligomer” in this context includes a molecule formed from two to ten units, where the units are obtainable from the at least one alkyl (meth)acrylate, the at least one further alkyl (meth)acrylate and mixtures thereof.

“Polymers” in this context mean polymers of the at least one alkyl (meth)acrylate, the at least one further alkyl (meth)acrylate and of mixtures thereof. For example, a polymer in this context comprises 1000 to 100 000 units, where the units are obtainable from the at least one alkyl (meth)acrylate, the at least one further alkyl (meth)acrylate and mixtures thereof.

In step f), the syrup obtained in step e) is polymerized in a vented extruder. This affords a polymer mixture containing the poly(alkyl (meth)acrylate).

The temperature in the vented extruder in step f) is, for example, in the range from 150 to 290° C., preferably in the range from 170 to 270° C.

The pressure in the degassing region of the vented extruder in step f) is, for example, in the range from 0.1 bara to 2 bara, preferably in the range from 0.15 bara to 0.3 bara.

Suitable vented extruders are vented extruders known to the person skilled in the art. Suitable vented extruders are described, for example, in EP 2 212 091 A1 and WO 2009/040190 A1.

Typically, the syrup obtained in step e) is fed to the vented extruder via a material feed and then moved onward therein, in the course of which the syrup polymerizes to obtain the polymer mixture. The syrup and the polymer mixture are thus conveyed along the vented extruder. At the extruder outlet, the polymer mixture obtained is discharged from the extruder. The extruder outlet is typically at the opposite end of the extruder from the material feed.

The polymerization in step f) affords the polymer mixture. The polymer mixture contains the poly(alkyl (meth)acrylate). In addition, the polymer mixture may contain components of the syrup.

The poly(alkyl (meth)acrylate) present in the polymer mixture is correspondingly subject to the details and preferences described above.

In step g) of the process of the invention, the syrup obtained in step e) and/or the polymer mixture obtained in step f) is degassed in the vented extruder to obtain a condensate stream. The condensate stream contains the at least one alkyl (meth)acrylate, the at least one further alkyl (meth)acrylate, oligomers thereof and the at least one further alkyl ester.

Degassing in the vented extruder can take place by methods known to the person skilled in the art. The polymerization in step f) preferably takes place simultaneously with the degassing in step g).

Preference is therefore also given to a process in which steps f) and g) are conducted simultaneously.

In the context of the present invention, “degassing” means that volatile constituents of the syrup and/or of the polymer mixture, i.e. in particular the at least one alkyl (meth)acrylate, the at least one further alkyl (meth)acrylate, oligomers thereof and the at least one further alkyl ester, are removed from the syrup and/or the polymer mixture. These volatile constituents are obtained as a condensate stream.

The condensate stream contains, for example, a total in the range from 75% by weight to 85% by weight of the at least one alkyl (meth)acrylate and the at least one further alkyl (meth)acrylate, in the range from 0.1% by weight to 5% by weight of the at least one further alkyl ester and in the range from 10% by weight to 20% by weight of other constituents, based in each case on the total weight of the condensate stream. The other constituents include, for example, oligomers of the at least one alkyl (meth)acrylate and the at least one further alkyl (meth)acrylate.

The degassing in step g) can be conducted in the vented extruders known to the person skilled in the art. The degassing is preferably effected in a vented extruder as described, for example, in EP 2 212 091 A1 and in WO 2009/040190 A1.

It is preferable that the removal of the condensate stream is essentially in the opposite direction to the conveying direction of the syrup and/or the polymer mixture. The polymer mixture is thus conveyed out of the vented extruder in the opposite direction from the degassing.

Preference is therefore also given to a process in which the degassing in step g) is effected in countercurrent to the conveying direction of the polymer mixture obtained in step f).

This type of vented extruder is described, for example, in EP 2 212 091 A1 and WO 2009/040190 A1.

It is further preferable that the degassing is effected in at least two steps; for example, a first degassing operation is effected in the first third of the vented extruder and a second degassing operation in the last third of the vented extruder. The first degassing operation is preferably effected at ambient pressure, while the second degassing operation is effected under reduced pressure.

The condensate stream is typically obtained in gaseous form. It is possible and preferable in accordance with the invention that the condensate stream is condensed after step g) and before step h).

What is therefore typically obtained at first is a degassing stream, which is then condensed to give a condensate stream. If degassing in the vented extruder is effected in at least two steps, for example, the first degassing operation affords a first degassing stream and the second degassing operation a second degassing stream.

In step h), the at least one further alkyl ester is removed from the condensate stream obtained in step g) to obtain an alkyl (meth)acrylate stream. The alkyl (meth)acrylate stream contains the at least one alkyl (meth)acrylate and the at least one further alkyl (meth)acrylate.

If the optional step d) is conducted in an embodiment which is preferred in accordance with the invention, residues of the at least one further alkyl ester are removed in step h) from the condensate stream obtained in step g). The details and preferences described hereinafter for the at least one further alkyl ester are therefore correspondingly applicable to the residues of the at least one further alkyl ester.

The at least one further alkyl ester is typically removed in the purification section of the poly(alkyl (meth)acrylate) production process.

In the context of the present invention, the term “purification section” means the part of the poly(alkyl (meth)acrylate) production process in which the condensate stream is purified so as to obtain the alkyl (meth)acrylate stream. In particular, the at least one further alkyl ester is at least partly separated off in the purification section, as are any oligomers present in the condensate stream. The purification section typically comprises devices for removal of components, for example distillation columns, rectification columns and/or thin-film evaporators.

Processes for purifying the condensate stream and in particular for separating the at least one further alkyl ester from the condensate stream are known as such. For example, the at least one further alkyl ester can be removed by distillation. The at least one further alkyl ester is preferably separated off in at least two steps.

For example, step h) includes the following step h1):
h1) separating the condensate stream into a second top stream comprising the at least one further alkyl (meth)acrylate and the at least one further alkyl ester, and a second bottom stream comprising oligomers of the at least one alkyl (meth)acrylate and oligomers of the at least one further alkyl (meth)acrylate.

The condensate stream can be separated into the second top stream and the second bottom stream by methods known to the person skilled in the art. For example by distillation and/or rectification and/or thin-film evaporation.

The following step h2) is preferably performed after step h1):
h2) distilling the second top stream obtained in step h1) to obtain a third top stream comprising the at least one further alkyl ester and a third bottom stream comprising the at least one alkyl (meth)acrylate and the at least one further alkyl (meth)acrylate.

Preference is therefore also given to a process in which the removal in step h) comprises the following steps:
h1) separating the condensate stream into a second top stream comprising the at least one alkyl (meth)acrylate, the at least one further alkyl (meth)acrylate and the at least one further alkyl ester, and a second bottom stream comprising oligomers of the at least one alkyl (meth)acrylate and oligomers of the at least one further alkyl (meth)acrylate,
h2) distilling the second top stream obtained in step h1) to obtain a third top stream comprising the at least one further alkyl ester and a third bottom stream comprising the at least one alkyl (meth)acrylate and the at least one further alkyl (meth)acrylate.

Typically, the second top stream obtained in step h1) is transferred continuously into the distillation in step h2).

The third bottom stream which is obtained in step h2) comprises the alkyl (meth)acrylate stream.

The alkyl (meth)acrylate stream obtained in step h) and/or the third bottom stream obtained in step h2) can be at least partly recycled into at least one of steps c), e) and/or f).

Preference is therefore also given to a process in which the alkyl (meth)acrylate stream obtained in step h) is at least partly recycled into at least one of steps c), e) and/or f).

It is preferable in accordance with the invention that, in step c), the first liquid stream obtained in step b) is mixed with the condensate stream before or during step h). In this case, the further stream corresponds to the condensate stream. This embodiment is particularly advantageous since step h) can then include the optional step d).

Preference is therefore also given to a process in which step h) includes step d).

If step h) includes step d), the at least one alkyl ester can be separated from the mixture stream together with the residues of the at least one alkyl ester from the condensate stream.

The present invention further provides a process for producing a poly(alkyl (meth)acrylate), comprising the following steps c1) to h):
c1) mixing a first liquid stream comprising the at least one alkyl (meth)acrylate and at least one further alkyl ester, the first liquid stream being obtainable by thermal cracking of at least one polymer composition, with a further stream containing at least one further alkyl (meth)acrylate, the further stream being part of a poly(alkyl (meth)acrylate) production process, to obtain a mixture stream comprising the first liquid stream and the further stream,
e) partly polymerizing the mixture stream obtained in step c1) to obtain a syrup comprising at least one alkyl (meth)acrylate in partly polymerized form, at least one further alkyl (meth)acrylate in partly polymerized form, and the at least one further alkyl ester,
f) polymerizing the syrup obtained in step e) in a vented extruder to obtain a polymer mixture comprising the poly(alkyl (meth)acrylate),
g) degassing the syrup obtained in step e) and/or the polymer mixture obtained in step f) in the vented extruder to obtain a condensate stream comprising the at least one alkyl (meth)acrylate, the at least one further alkyl (meth)acrylate, oligomers thereof and the at least one further alkyl ester,
h) separating the residues of the at least one further alkyl ester from the condensate stream obtained in step g) to obtain an alkyl (meth)acrylate stream comprising the at least one alkyl (meth)acrylate and the at least one further alkyl (meth)acrylate.

In step c1), the first liquid stream is mixed with the further stream. The first liquid stream is obtainable by thermal cracking of at least one polymer composition. The polymer composition is subject to the above-described observations and preferences.

The first liquid stream is therefore preferably obtainable via the following steps a) and b):
a) thermally cracking at least one polymer composition comprising at least one poly(alkyl (meth)acrylate) to obtain a first gas stream comprising at least one alkyl (meth)acrylate and at least one further alkyl ester,
b) condensing the first gas stream obtained in step a) to obtain the first liquid stream comprising the at least one alkyl (meth)acrylate and the at least one further alkyl ester.

Steps a) and b) are correspondingly subject to the details and preferences described above.

The first liquid stream is likewise correspondingly subject to the details and preferences described above. Step c1) is correspondingly subject to the details and preferences described above for step c).

Steps e) to h) are correspondingly subject to the details described above.

In a preferred embodiment, the above-described step d) is additionally conducted after step c1) and before step e).

### FIGURES

FIG. 1: Process for producing a poly(alkyl (meth)acrylate) according to the prior art

FIG. 2: A first embodiment of the process of the invention for producing a poly(alkyl (meth)acrylate)

FIG. 3: A second embodiment of the process of the invention for producing a poly(alkyl (meth)acrylate

The present invention is described in detail hereinafter with reference to figures, but without restricting the invention thereto.

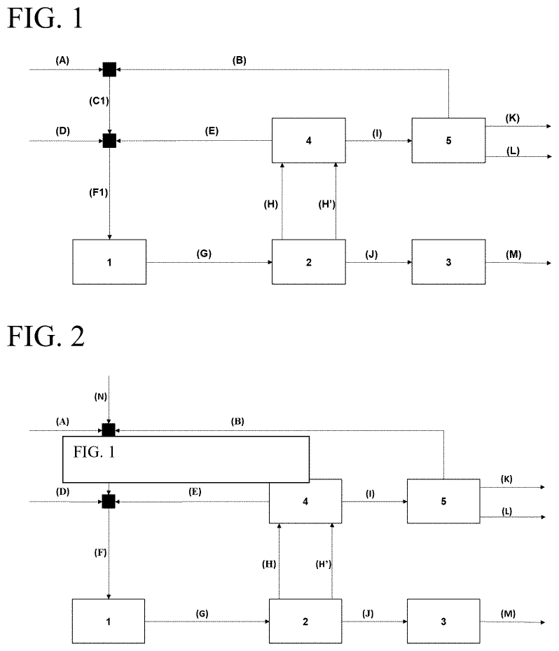

FIG. 1 shows a process for producing a poly(alkyl (meth)acrylate) according to the prior art. A further stream (A) comprising at least one further alkyl (meth)acrylate is mixed with a third bottom stream (B) likewise comprising at least one further alkyl (meth)acrylate to obtain a mixed stream (C1). The third bottom stream (B) is obtainable in the purification section 5 of the process as described further down.

The mixed stream (C1) is mixed with an additive stream (D) and a standard-pressure condensate (E) to obtain a second mixed stream (F1). This second mixed stream (F1) is transferred to a polymerization reactor 1. The second mixed stream (F1) is partly polymerized therein to obtain a syrup (G) comprising at least one further alkyl (meth)acrylate in partly polymerized form. In addition, the syrup (G) comprises at least one further alkyl (meth)acrylate in as yet unpolymerized form. The syrup (G) is then transferred to a vented extruder 2. The syrup (G) is further polymerized therein to obtain a degassed polymer mixture (J) comprising the poly(alkyl (meth)acrylate).

In the vented extruder 2, the syrup (G) and/or the polymer mixture (J) are degassed to obtain a condensate stream. In the embodiment shown in FIG. 1, the syrup (G) and/or the polymer mixture (J) is first degassed in a first region of the vented extruder 2 at ambient pressure to obtain a first degassing stream (H). A further degassing step is effected in a second region of the vented extruder 2 under reduced pressure to obtain a second degassing stream (H′).

The first degassing stream (H) is condensed in the condensation 4 to obtain the standard-pressure condensate (E), which is at least partly mixed with the mixed stream (C1). It is also possible to mix portions of the standard-pressure condensate (E) with the syrup (G) (not shown in FIG. 1).

The second degassing stream (H′) is likewise condensed in the condensation 4. This affords the vacuum degassing condensate (I). This is at least partly transferred to the purification section 5. It is possible to mix portions of the vacuum degassing condensate (I) with the standard-pressure condensate (E) (not shown in FIG. 1). The vacuum degassing condensate (I) is purified in the purification section 5. The purification section 5 may comprise, for example, a thin-film evaporator and a rectification column. In the thin-film evaporator, the vacuum degassing condensate (I) is partly evaporated to obtain a second top stream (not shown) and a second bottom stream (L). The second top stream is then transferred to the rectification column and transferred to a third top stream (K) and the third bottom stream (B).

The polymer mixture (J) is processed in the polymer processing 3 to give polymer pellets (M) by known methods.

FIG. 2 shows a first embodiment of the process of the invention for producing a poly(alkyl (meth)acrylate). Identical reference symbols to those in FIG. 1 have the same meaning.

A further stream (A) comprising at least one further alkyl (meth)acrylate is mixed with a third bottom stream (B) comprising at least one alkyl (meth)acrylate and at least one further alkyl (meth)acrylate, and with a first liquid stream (N) comprising at least one alkyl (meth)acrylate and at least one further alkyl ester to obtain a mixture stream (C).

The third bottom stream (B) is obtainable in the purification section 5 of the process, as described further down.

The mixture stream (C) is mixed with an additive stream (D) and a standard-pressure condensate (E) to obtain a second mixture stream (F). This second mixture stream (F) is transferred to a polymerization reactor 1. The second mixture stream (F) is partly polymerized therein to obtain a syrup (G) comprising at least one alkyl (meth)acrylate in partly polymerized form, at least one further alkyl (meth)acrylate in partly polymerized form, and the at least one further alkyl ester. The syrup (G) also comprises at least one alkyl (meth)acrylate in unpolymerized form and at least one further alkyl (meth)acrylate in unpolymerized form. The syrup (G) is then transferred to a vented extruder 2. The syrup (G) is further polymerized therein to obtain a degassed polymer mixture (J) comprising the poly(alkyl (meth)acrylate).

In the vented extruder 2, the syrup (G) and/or the polymer mixture (J) is degassed as described above for FIG. 1, and the first degassing stream (H) obtained and the second degassing stream (H′) are condensed in the condensation 4. The vacuum degassing condensate (I) thus obtained is purified as described for FIG. 1 and the third bottom stream (B) obtained is recycled.

The polymer mixture (J) is processed in the polymer processing 3 to give polymer pellets (M) by known methods.

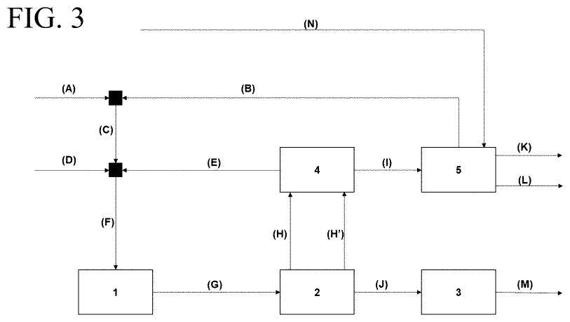

FIG. 3 shows a further embodiment of the process of the invention. Identical reference symbols in FIG. 3 to those in FIG. 2 have the same meaning. All that are described in detail hereinafter are the differences from according to FIG. 2.

The first liquid stream (N) comprising the at least one alkyl (meth)acrylate and the at least one further alkyl ester is fed directly to the workup section 5 and purified together with the vacuum degassing condensate (I), for example, by means of a thin-film condenser and a rectification column, to obtain the third bottom stream (B), which is then mixed with the further stream (A). In this embodiment, the first liquid stream (N) is thus mixed with the vacuum degassing condensate (I) which comprises the at least one further alkyl (meth)acrylate inter alia and is part of the poly(alkyl (meth)acrylate) production process, such that, in this embodiment, the vacuum degassing condensate (I) is a further stream according to step c) of the process of the invention.

The third bottom stream (B) is then mixed with the further stream (A) as described for FIG. 2 to obtain the mixture stream. The further process steps in FIG. 3 are analogous to those described in FIG. 1.

### LIST OF REFERENCE SYMBOLS

(A) further stream
(B) third bottom stream
(C) mixture stream
(C1) mixed stream
(D) additive stream
(E) normal-pressure condensate
(F) second mixture stream
(F1) second mixed stream
(G) syrup
(H) first degassing stream
(H′) second degassing stream
(I) vacuum degassing condensate
(J) degassed polymer mixture
(K) third top stream
(L) second bottom stream
(M) polymer pellets
(N) first liquid stream
1 polymerization reactor
2 vented extruder
3 polymer processing
4 condensation
5 purification section

The present invention is described in detail hereinafter by examples, but without restricting it thereto.

### EXAMPLES

Preparation of Polymethylmethacrylate (PMMA) in a Two-Stage Polymerization Proceeding from Different Monomer Compositions

A further stream was provided by a C₃ production process for MMA. Table 1 shows the composition of the further stream obtained.

TABLE 1

| Stream | Substance | Concentration | Unit |
|---|---|---|---|
| (A) | Methyl methacrylate (MMA) | >99.98 | % by wt. |
| (A) | Methyl acrylate | 3 | ppm by wt. |
| (A) | Diacetyl | 1 | ppm by wt. |
| (A) | Dimeric MMA (DMMA) | 2 | ppm by wt. |
| (A) | Methyl propionate | 100 | ppm by wt. |
| (A) | Methyl isobutyrate | 50 | ppm by wt. |
| (A) | Water | 20 | ppm by wt. |
| (A) | Sum total of unknown | 20 | ppm by wt. |
| | compounds | | |

Two different first liquid streams were obtained by depolymerization of poly(methyl methacrylate). The composition of each first liquid stream obtained is given in tables 2 and 3.

TABLE 2

| Stream | Substance | Concentration | Unit |
|---|---|---|---|
| (N) | MMA | 97.9 | % by wt. |
| (N) | Acetone | 100 | ppm by wt. |
| (N) | Methanol | 120 | ppm by wt. |
| (N) | Methyl acrylate | 5000 | ppm by wt. |
| (N) | Methyl propionate | 1000 | ppm by wt. |
| (N) | Methyl isobutyrate | 5000 | ppm by wt. |
| (N) | Diacetyl | 50 | ppm by wt. |
| (N) | DMMA | 2000 | ppm by wt. |
| (N) | Methyl pyruvate | 15 | ppm by wt. |
| (N) | Total low boilers | 8000 | ppm by wt. |
| (N) | Total high boilers | 4900 | ppm by wt. |

TABLE 3

| Stream | Substance | Concentration | Unit |
|---|---|---|---|
| (N) | MMA | 91.2 | % by wt. |
| (N) | Acetone | 110 | ppm by wt. |
| (N) | Methanol | 90 | ppm by wt. |
| (N) | Methyl acrylate | 9820 | ppm by wt. |
| (N) | Methyl propionate | 2000 | ppm by wt. |
| (N) | Methyl isobutyrate | 4940 | ppm by wt. |
| (N) | Diacetyl | 26 | ppm by wt. |
| (N) | DMMA | 9000 | ppm by wt. |
| (N) | Methyl pyruvate | 15 | ppm by wt. |
| (N) | Total low boilers | 11980 | ppm by wt. |
| (N) | Total high boilers | 54800 | ppm by wt. |

### Test Methods:

The compositions reported in tables 1, 2 and 3 were obtained by gas chromatography (Agilent 88990, standard addition: isopropanol).

The quality and physical properties of the polymethylmethacrylate (PMMA) products produced according to the examples were determined by the following methods: Yellowing(D65/10°) was determined by photometry (Varian Cary 5000) according to DIN 6167 (1980; 01). Melt volume flow rate (MVR) was determined according to DIN EN ISO 1133 (2012; 03) at 230° C. and with 3.8 kg of sample. Vicat softening temperature (VST) was determined per DIN EN ISO 306 (2014; 03).

### Comparative Example V1: Production of PMMA Proceeding from a Further Stream

PMMA was produced in a plant according to FIG. 1.

5000 kg/h of further stream (A) according to table 1 was mixed continuously at 8° C. with 384 kg/h of a third bottom stream (B) in a static mixer. The third bottom stream (B) had an MMA concentration of 98.8%, based on the total amount of third bottom stream (B). The third bottom stream (B) was recycled from the purification section 5 described below and was at a temperature of 10° C. The purification section 5 comprises a thin-film evaporator coupled with a rectification column.

Mixing of the further stream (A) with the third bottom stream (B) afforded a mixed stream (C1) comprising the further stream (A) and the third bottom stream (B). The mixed stream (C1) was mixed with 100 kg/h of an additive stream (D). The additive stream (D) comprised palmitin as release agent, high boilers as additives and polymerization regulators such as dodecylmercaptan dissolved in MMA. The MMA concentration was >90% by weight. In addition, a standard-pressure condensate (E) was added, which contained about 90% MMA and had a temperature of 5° C. The standard-pressure condensate (E) was obtained in the condensation 4 as described below.

The second mixed stream (F1) obtained in the course of mixing, which amounted to 18 200 kg/h, was then heated to 150° C. in a shell and tube heat exchanger and fed to a polymerization reactor 1 having a capacity of 10 m³ for partial polymerization. Addition of 5 kg/h of initiator solution (not shown in FIG. 1) resulted in continuous polymerization of the second mixed stream (F1) at 150° C. and slightly elevated pressure, with establishment of a degree of conversion of about 45%. The dwell time was about 10 min.

The syrup (G) obtained was then preheated to about 210° C. on the tube side in a shell and tube heat exchanger and run into the vented extruder 2 as a stream at about 12 800 kg/h. The vented extruder was operated with a temperature profile from 170° C. to 270° C. and degassed in two places. The first degassing to obtain a first degassing stream (H) took place at ambient pressure in the first third of the vented extruder 2; the second degassing to obtain a second degassing stream (H′) took place under a reduced pressure of about 150 mbara.

The first degassing stream (H) obtained at standard pressure was condensed at 5° C. and used as standard-pressure condensate (E). About 5% of the standard-pressure condensate (E) was mixed with the vacuum degassing condensate (I) (not shown in FIG. 1) before it was fed to the purification section 5.

509 kg/h of the vacuum degassing condensate (I) was fed to the purification section 5. This included a DN500 thin-film evaporator coupled with a DN400 rectification column. The thin-film evaporator was operated at 190 mbara and 75° C. and had a special wiper design (DVB type from SMS Buss). Spring-loaded PTFE wiper blades were used, which cause little friction and hence local heating. The apparatus was heated with 1 barg of saturated steam on the shell side, which provided an exchange area of 4 m². The vacuum degassing condensate (I), before being fed into thermal processing, was admixed with a stabilizer mixture comprising 2,4-dimethyl-6-tert-butylphenol (Topanol A) and 1,6-di-tert-butyl-4-methylphenol (Topanol O) dissolved in MMA. The concentration was about 200 ppm. The stabilized cold vacuum degassing condensate (I) was partially evaporated so as to obtain a second top stream and a second bottom stream (L). 98 kg/h of the second bottom stream (L), which still contained about 25% MMA, was discharged from the process. The thin-film evaporator was supplied continuously with 0.5 m³ (STP)/h of air in order to promote the effect of the stabilizer mixture.

The second top stream obtained was then fed to a rectification column equipped centrally with 6 m of structured packing (MP452Y type). The rectification column was operated at 180 mbara, 55° C. in the bottom, and 29 C at the top. The vacuum was generated with a liquid-ring vacuum pump that was operated with further stream (A) from the PMMA process as working fluid (not shown in FIG. 1). The energy was introduced into the rectification column via a natural circulation evaporator heated with 1 barg saturated steam with a short dwell time. The evaporator was likewise supplied continuously with 0.5 m³ (STP)/h of air in order to promote the effect of the stabilizer. Condensation at the top was effected in two shell and tube heat exchangers that were operated with cooling water (20° C.) and brine (2° C.). At a reflux ratio of 0.95, the third top stream (K) was removed continuously from the process at the top of the column. The third bottom stream (B) was mixed with the further stream (A) as described above.

The degassed polymer mixture (J) obtained in the vented extruder 2 essentially comprises PMMA. This was withdrawn as a continuous strand of sheet material, solidified in a water bath and processed to polymer pellets (M), consisting essentially of PMMA. The mass flow rate of the polymer pellets (M) was about 4975 kg/h.

For the polymer pellets (M) thus obtained, quality and physical properties were determined as described above. The results can be found in table 4.

### Inventive Example B1: Production of PMMA Proceeding from a First Liquid Stream and a Further Stream

PMMA was produced in a plant according to FIG. 2.

The production was essentially analogous to the production described in comparative example V1. The same reference symbols in the figures therefore have the same meaning. Therefore, there follows a description essentially of the changes in the method compared to the method according to comparative example V1. 5000 kg/h of further stream (A) according to table 1 was mixed continuously at 8° C. with 640 kg/h of first liquid stream (N) according to table 2 and 385 kg/h of a third bottom stream (B) in a static mixer to obtain a mixture stream (C). The third bottom stream (B) had an MMA concentration of 97.3%, based on the total amount of third bottom stream (B). The third bottom stream (B) was obtained by recycling as described in comparative example V1. The mixing ratio of first liquid stream (N) to further stream (A) is stated in table 4.

The mixture stream (C) was supplied with an additive stream (D) and a stream of a standard-pressure condensate (E), which amounted to 14 390 kg/h, to obtain a second mixture stream (F) that amounted to about 20 400 kg/h. The by-products present in the second mixture stream (F) are listed in table 4. The second mixture stream was then fed to a polymerization reactor 1 and processed further analogously to comparative example V1.

The for the polymer pellets (M) obtained, quality and physical properties were determined as described above. The results can be found in table 4.

### Inventive Example B2: Production of PMMA Proceeding from a First Liquid Stream and a Further Stream

PMMA was produced in a plant according to FIG. 2.

The production was essentially analogous to the production described in inventive example B1. Therefore, there follows a description essentially of the changes in the method compared to the method according to inventive example B1.

5000 kg/h of further stream (A) according to table 1 was mixed continuously at 8° C. with 160 kg/h of first liquid stream (N) according to table 2 and 391 kg/h of a third bottom stream (B) in a static mixer to obtain a mixture stream (C). The third bottom stream (B) had an MMA concentration of 97.2%, based on the total amount of third bottom stream (B). The third bottom stream (B) was obtained by recycling as described in comparative example V1. The mixing ratio of first liquid stream (N) to further stream (A) is stated in table 4.

The mixture stream (C) was supplied with an additive stream (D) and a stream of a standard-pressure condensate (E), which amounted to 13 180 kg/h, to obtain a second mixture stream (F) that amounted to about 18 840 kg/h. The by-products present in the second mixture stream (F) are listed in table 4. The second mixture stream was then fed to a polymerization reactor 1 and processed further analogously to comparative example V1.

For the polymer pellets (M) obtained, quality and physical properties were determined as described above. The results can be found in table 4.

### Inventive Example B3: Production of PMMA Proceeding from a Purified First Liquid Stream and a Further Stream

PMMA was produced in a plant according to FIG. 3.

The production was essentially analogous to the production described in comparative example V1. The same reference symbols in the figures therefore have the same meaning. Therefore, there follows a description essentially of the changes in the method compared to the method according to comparative example V1.

5000 kg/h of further stream (A) according to table 1 was mixed continuously at 8° C. with 1575 kg/h of a third bottom stream (B) in a static mixer to obtain a mixture stream (C). The third bottom stream (B) had an MMA concentration of 98.6%. The third bottom stream (B) was obtained by recycling. In the purification section 5, first liquid stream (N) was mixed into the vacuum degassing condensate (I) according to table 2 and the two streams were purified together as described further down to obtain the third bottom stream (B).

Additive stream (D) and a stream of a standard-pressure condensate (E), which amounted to 15 570 kg/h, was then mixed into the mixture stream (C) as described in comparative example V1 to obtain a second mixture stream (F) that amounted to about 22 240 kg/h. The by-products present in the second mixture stream (F) are listed in table 4. The second mixture stream (F) was then fed to a polymerization reactor 1 and processed further analogously to comparative example V1.

532 kg/h of the vacuum degassing condensate (I) was mixed with the first liquid stream (N) according to table 2 in the purification section 5 as described in comparative example V1 and purified. The reflux ratio of the rectification column was 1.5. The third bottom stream (B) obtained was mixed with the further stream (A) as described above.

For the polymer pellets (M) obtained, quality and physical properties were determined as described above. The results can be found in table 4.

### Inventive Example B4: Production of PMMA Proceeding from a Purified First Liquid Stream and a Further Stream

PMMA was produced in a plant according to FIG. 3.

The production was essentially analogous to the production described in inventive example B3. Therefore, there follows a description essentially of the changes in the method compared to the method according to inventive example B3.

5000 kg/h of further stream (A) according to table 1 was mixed continuously at 8° C. with 723 kg/h of a third bottom stream (B) in a static mixer to obtain a mixture stream (C). The third bottom stream (B) had an MMA concentration of 97.3%. The third bottom stream (B) was obtained by recycling. In the purification section 5, first liquid stream (N) was mixed into the vacuum degassing condensate (I) according to table 3 and the two streams were purified as described further down to obtain the third bottom stream (B).

Additive stream (D) and a stream of a standard-pressure condensate (E), which amounted to 13 580 kg/h, was then mixed into the mixture stream (C) as described in comparative example V1 to obtain a second mixture stream (F) that amounted to about 19 400 kg/h. The by-products present in the second mixture stream (F) are listed in table 4. The second mixture stream (F) was then fed to a polymerization reactor 1 and processed further analogously to comparative example V1.

530 kg/h of the vacuum degassing condensate (I) was mixed with the first liquid stream (N) according to table 3 in purification section 5 as described in inventive example B3 and purified.

For the polymer pellets (M) obtained, quality and physical properties were determined as described above. The results can be found in table 4.

### Inventive Example B5: Production of PMMA Proceeding from a Purified First Liquid Stream and a Further Stream

PMMA was produced in a plant according to FIG. 3.

The production was essentially analogous to the production described in inventive example B3. Therefore, there follows a description essentially of the changes in the method compared to the method according to inventive example B3.

5000 kg/h of further stream (A) according to table 1 was mixed continuously at 8° C. with 2360 kg/h of a third bottom stream (B) in a static mixer to obtain a mixture stream (C). The third bottom stream (B) had an MMA concentration of 96.4%. The third bottom stream (B) was obtained by recycling. In the purification section 5, first liquid stream (N) was mixed into the vacuum degassing condensate (I) according to table 3 and the two streams were purified as described further down to obtain the third bottom stream (B).

Additive stream (D) and a stream of a standard-pressure condensate (E), which amounted to about 17 400 kg/h, was then mixed into the mixture stream (C) as described in comparative example V1 to obtain a second mixture stream (F) that amounted to about 24 860 kg/h. The by-products present in the second mixture stream (F) are listed in table 4. The second mixture stream (F) was then fed to a polymerization reactor 1 and processed further analogously to comparative example V1.

535 kg/h of the vacuum degassing condensate (I) was mixed with the first liquid stream (N) according to table 3 in purification section 5 as described in inventive example B3 and purified.

For the polymer pellets (M) obtained, quality and physical properties were determined as described above. The results can be found in table 4.

TABLE 4

| Stream | Description | Unit | V1 | B1 | B2 | B3 | B4 | B5 |
|---|---|---|---|---|---|---|---|---|
| (A) | Pure MMA feed stream | kg/h | 5000 | 5000 | 5000 | 5000 | 5000 | 5000 |
| | (Quality: cf. table 1) | | | | | | | |
| (D) | Additive stream (>90 wt % | kg/h | 100 | 100 | 100 | 100 | 100 | 100 |
| | MMA) | | | | | | | |
| (N) | MMA content of recycled | % by wt. | — | 97.9 | 91.2 | 97.9 | 91.2 | 91.2 |
| | material | | | | | | | |
| (N) | Recycled MMA in reactor | kg/h | — | 640 | 160 | — | — | — |
| (N) | Recycled MMA in | kg/h | — | — | — | 1210 | 370 | 2120 |
| | purification | | | | | | | |
| (N)/(A) | Ratio of recycled MMA to | % | — | 12.8 | 3.2 | 24.2 | 7.4 | 42.4 |
| | fresh MMA | | | | | | | |
| (N)/(M) | Use factor of recycled | % | — | 11.4 | 3.1 | 19.7 | 7.0 | 30.6 |
| | MMA based on PMMA | | | | | | | |
| | product | | | | | | | |
| | Monomer loss in stream | kg/h | 25 | 40 | 65 | 39 | 45 | 51 |
| | (K and L) | | | | | | | |
| (M) | PMMA yield | % by wt. | 97.8 | 97.4 | 97.0 | 97.3 | 96.7 | 95.9 |
| (K) | Low boiler discharge | % of (M) | 0.5 | 0.6 | 0.7 | 0.8 | 0.9 | 1.2 |
| (L) | High boiler discharge | % of (M) | 1.9 | 2.0 | 2.4 | 1.9 | 2.5 | 3.1 |
| (L) | Oligomer/polymer | % by wt. | 11 | 18 | 23 | 17 | 24 | 41 |
| | content | | | | | | | |
| (F) | Acetone | ppm by wt. | 120 | 230 | 290 | 80 | 120 | 240 |
| (F) | Methanol | ppm by wt. | 30 | 195 | 260 | 140 | 160 | 220 |
| (F) | Diacetyl | ppm by wt. | 19 | 24 | 31 | 17 | 23 | 48 |
| (F) | Methyl acrylate | ppm by wt. | 3900 | 9840 | 11020 | 4200 | 4600 | 5030 |
| (F) | Methyl pyruvate | ppm by wt. | 650 | 720 | 790 | 690 | 740 | 1370 |
| (F) | Methyl propionate | ppm by wt. | 1680 | 2210 | 2420 | 1890 | 2060 | 2720 |
| (F) | Methyl isobutyrate | ppm by wt. | 4250 | 5370 | 6540 | 4430 | 4730 | 7540 |
| (F) | Unknown compounds | % by wt. | 1.7 | 2.4 | 2.7 | 1.9 | 2.0 | 3.1 |
| (M) | PMMA quality sufficient | | Yes | Yes | No | Yes | Yes | No |
| | for crystal-clear product? | | | | | | | |
| (M) | PMMA quality sufficient | | Yes | Yes | Yes | Yes | Yes | Yes |
| | for colored product? | | | | | | | |
| (M) | Percentage of extrinsic | ppm by wt. | 250 | 1420 | 3160 | 640 | 780 | 960 |
| | polymers (PA, PAN, POM | | | | | | | |
| | etc.) | | | | | | | |
| (M) | Transmittance (450 nm) | % by wt. | 93.5 | 92.8 | 92.4 | 93.2 | 93.1 | 90.2 |
| (M) | Yellowness index (Y.I.) | | 1.1 | 2.0 | 10.4 | 1.2 | 2.2 | 29 |
| | 148 mm | | | | | | | |
| (M) | Melt volume flow rate | ml/10 min | 2.7 | 2.6 | 2.2 | 2.7 | 2.7 | 2.2 |
| | MVR | | | | | | | |
| (M) | Vicat softening temp. VST | ° C. | 107.5 | 106.5 | 105.5 | 107 | 107 | 105 |

It is apparent from the results shown in table 4 that production of PMMA from pure MMA in combination with recycled MMA is possible. PMMA produced in accordance with the invention has transmittance sufficient for the application and a sufficiently low yellowness index to produce at least colored products. Melt volume flow rate is sufficient, with a simultaneously high Vicat softening temperature. It is thus possible through the process of the invention to save resources and to recycle MMA with the same good product quality.

PMMA which can also be used as crystal-clear PMMA is obtained when either the recycled MMA used already has high purity (examples B1 and B3) and/or is purified together with the vacuum degassing condensate before it is mixed with the pure MMA (examples B3, B4 and B5). The latter also allows the use of larger amounts of recycled MMA even if it is of lower purity.

1. A process for producing a poly(alkyl (meth)acrylate), the process comprising:
a) thermally cracking at least one polymer composition comprising at least one poly(alkyl (meth)acrylate) to obtain a first gas stream comprising at least one alkyl (meth)acrylate and at least one further alkyl ester, where the at least one alkyl (meth)acrylate present in the first gas stream is selected from the group consisting of C₁- to C₄-alkyl (meth)acrylates,
b) condensing the first gas stream obtained in a) to obtain a first liquid stream comprising the at least one alkyl (meth)acrylate and the at least one further alkyl ester,
c) mixing the first liquid stream obtained in b) with a further stream comprising at least one further alkyl (meth)acrylate, the further stream being part of a poly(alkyl (meth)acrylate) production process, to obtain a mixture stream comprising the first liquid stream and the further stream, where up to 50% by weight of the first liquid stream is mixed with the further stream, based on a total weight of the mixture stream obtained,
e) partly polymerizing the mixture stream obtained in c) to obtain a syrup comprising at least one alkyl (meth)acrylate in partly polymerized form, at least one further alkyl (meth)acrylate in partly polymerized form, and the at least one further alkyl ester,
f) polymerizing the syrup obtained in e) in a vented extruder to obtain a polymer mixture comprising the poly(alkyl (meth)acrylate),
g) degassing the syrup obtained in e) and/or the polymer mixture obtained in f) in the vented extruder to obtain a condensate stream comprising the at least one alkyl (meth)acrylate, the at least one further alkyl (meth)acrylate, oligomers thereof and the at least one further alkyl ester, and
h) separating the at least one further alkyl ester from the condensate stream obtained in g) to obtain an alkyl (meth)acrylate stream comprising the at least one alkyl (meth)acrylate and the at least one further alkyl (meth)acrylate.

2. The process as claimed in claim 1, wherein the method additionally comprises d) as follows:
d) at least partly separating the at least one further alkyl ester from the mixture stream obtained in c) to obtain a purified mixture stream comprising the at least one alkyl (meth)acrylate, the at least one further alkyl (meth)acrylate and residues of the at least one further alkyl ester,
in which case it is the purified mixture stream obtained in d) that is partly polymerized in e).

3. The process as claimed in claim 1, wherein the at least one further alkyl ester is selected from the group consisting of methyl propionate, methyl isobutyrate, methyl pivalate, methyl-3-methoxyisobutyrate and dicarboxylic diesters.

4. The process as claimed in claim 1, wherein the first gas stream comprises at least one further component selected from the group consisting of styrene, (meth)acrylic acid, sulfur compounds, oligomers and dimers.

5. The process as claimed in claim 1, wherein the first gas stream is distilled after a) and before b) to obtain a first top stream comprising the at least one alkyl (meth)acrylate and the at least one further alkyl ester, and a first bottom stream comprising at least one component other than the at least one alkyl (meth)acrylate and the at least one further alkyl ester, and the first top stream is condensed in b).

6. The process as claimed in claim 1, wherein the first liquid stream contains in a range of 90% to <99.8% by weight of the at least one alkyl (meth)acrylate, based on a total weight of the first liquid stream, and in that 1.5% to 50% by weight of the first liquid stream is mixed with the further stream, based on the total weight of the mixture stream obtained.

7. The process as claimed in claim 6, wherein, in the partial polymerization in e) takes place in presence of at least one auxiliary, and wherein the at least one auxiliary is selected from the group consisting of initiators, chain transfer agents and release agents.

8. The process as claimed in claim 1, wherein, in the partial polymerization in e), a total degree of conversion of the at least one alkyl (meth)acrylate and the at least one further alkyl (meth)acrylate is in a range from 20% to 60%, based on the amount of at least one alkyl (meth)acrylate and at least one further alkyl (meth)acrylate present in the purified mixture stream.

9. The process as claimed in claim 1, wherein f) and g) proceed simultaneously.

10. The process as claimed in claim 1, wherein the degassing in g) is effected in countercurrent to the conveying direction of the polymer mixture obtained in f).

11. The process as claimed in claim 1, wherein the at least one poly(alkyl (meth)acrylate) present in the polymer mixture is a poly(methyl (meth)acrylate).

12. The process as claimed in claim 1, wherein the separation in h) comprises the following:
h1) separating the condensate stream into a second top stream comprising the at least one alkyl (meth)acrylate, the at least one further alkyl (meth)acrylate and the at least one further alkyl ester, and a second bottom stream comprising oligomers of the at least one alkyl (meth)acrylate and oligomers of the at least one further alkyl (meth)acrylate,
h2) distilling the second top stream obtained in h1) to obtain a third top stream comprising the at least one further alkyl ester and a third bottom stream comprising the at least one alkyl (meth)acrylate and the at least one further alkyl (meth)acrylate.

13. The process as claimed in claim 1, wherein the alkyl (meth)acrylate stream obtained in h) is at least partly recycled into at least one of c), e) and/or f).

14. The process as claimed in claim 2, wherein h) includes d).
